(19) United States
(12) Patent Application Publication
(10) Pub. No.: US 2006/0158485 A1
(43) Pub. Date: Jul. 20, 2006

(54) Power switch system

(76) Inventors: Gregory S. Hill, Santa Rosa, CA (US); Stephane O. Roche, Rohnert Park, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/039,586

(22) Filed: Jan. 18, 2005

(51) Int. Cl. B41J 2/05

(52) U.S. Cl. 347/57

(57) ABSTRACT

A power switch system includes a transducer that converts mechanical power to electrical power that is provided to a monitor in response to the application of mechanical power to the transducer. The electrical power provided by the transducer can obviate the need for having the monitor draw power from a power source of an instrument when the instrument is in an OFF state.

### BACKGROUND OF THE INVENTION

Many types of electronic instruments are switched on and off by a manually activated power switch. When activated, the power switch typically grounds a signal line that is monitored by a monitor circuit. When the monitor circuit detects the grounded signal line, the monitor circuit closes a control switch, resulting in electrical power from a power source being applied to circuitry within the electronic instrument.

In order to detect transitions between an OFF state and an ON state in an electronic instrument, using a typical prior art power switching system (shown in FIG. 1), the monitor circuit is connected to the power source. Thus, the monitor circuit continuously draws current i from the power source, even when the instrument is in the OFF state. This presents a problem in battery-powered instruments because the monitor circuit discharges the battery, which can reduce available operating time of the instrument or render the instrument inoperable if the discharge is for a long enough time to drain the battery. For low-power instruments, power provided to the monitor circuit by the power source while the instrument is in the OFF state can be a substantial portion of the power-operating budget of the instrument.

### SUMMARY OF THE INVENTION

A power switch system according to embodiments of the present invention includes a transducer that converts mechanical power to electrical power. Upon mechanical activation of the transducer, electrical power is provided to a monitor that is included in the power switch system. The electrical power provided by the transducer can obviate the need for having the monitor draw power from a power source of an electronic instrument when the electronic instrument is in an OFF state.

### BRIEF DESCRIPTION OF THE DRAWINGS

FIG. 1 shows a prior art power switching system.

FIG. 2 shows an example of a power switch system according to embodiments of the present invention.

FIG. 3 shows one example of a transducer suitable for inclusion in the power switch system according to embodiments of the present invention.

FIGS. 4A-4B show detailed views of alternative examples of power conditioners included in the power switch system shown in FIG. 2.

FIG. 5 shows a flow diagram of one example of a power switch system according to alternative embodiments of the present invention.

FIG. 6 shows one example of a monitor suitable for inclusion in the power switch systems according to the embodiments of the present invention.

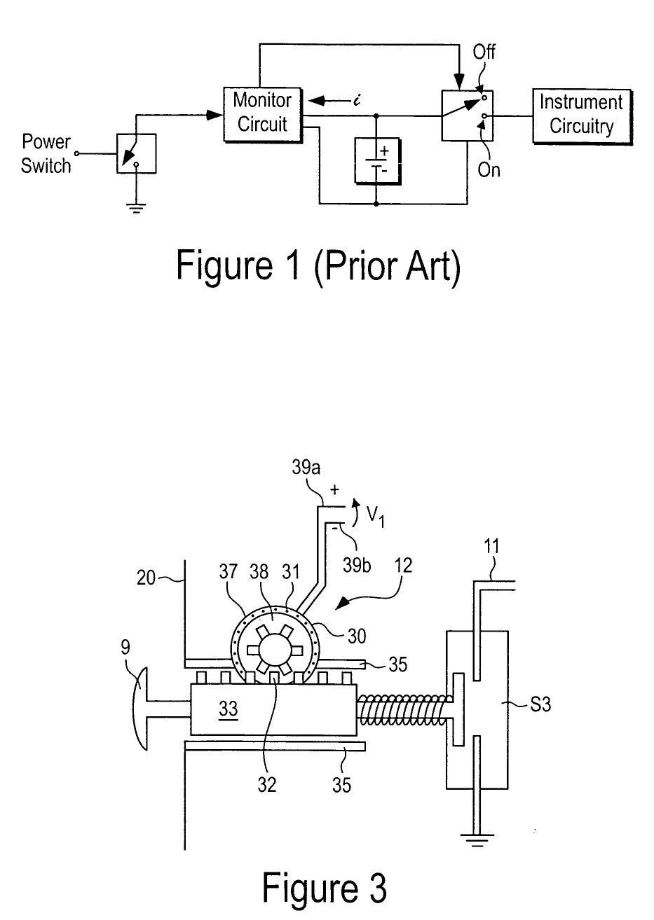

### DETAILED DESCRIPTION OF THE EMBODIMENTS

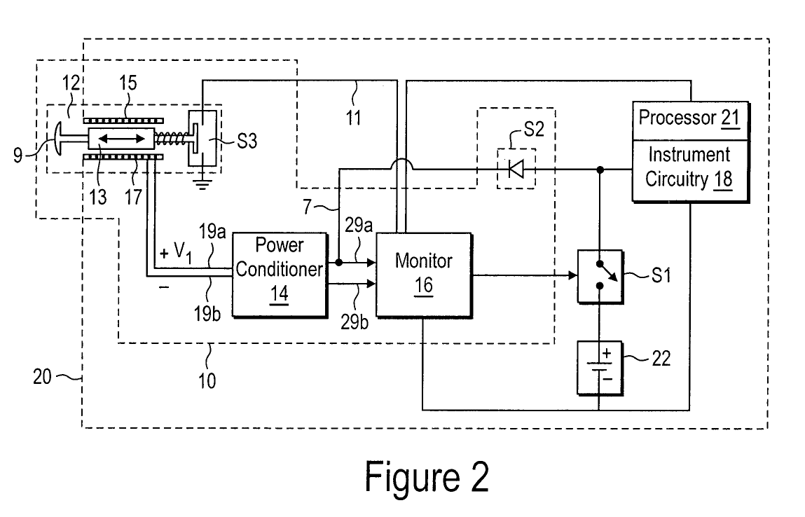

FIG. 2 shows one example of a power switch system 10 according to embodiments of the present invention. The power switch system 10 includes a transducer 12, a power conditioner 14, and a monitor 16. In this example, circuitry (hereinafter “instrument circuitry 18”) within an electronic instrument or other type of instrument 20 is selectively coupled to a power source 22 via a control switch SI. The instrument 20 can be any device, element, or system that is operated by a battery, fuel cell, power supply, or any other type of power source 22.

The transducer 12 is any device, element or system suitable for converting mechanical power to electrical power. Upon mechanical activation of the transducer 12, the transducer 12 provides electrical power to the monitor 16, which can obviate the need for having the monitor 16 draw power from the power source 22 when the instrument 20 is in an OFF state.

Typically, a user of the instrument 20 applies mechanical power to the transducer 12 by depressing, pulling, displacing or otherwise moving a movable portion of the transducer 12. In FIG. 2, the transducer 12 includes a linear emf (electromotive force) generator. The linear emf generator has a button 9 coupled to a displacement piston 13 that is slideably mounted within a sleeve 15. The sleeve 15 has a coil 17, or series of windings. The displacement piston 13 includes a magnet. Typically, the displacement piston 13 is magnetized or includes magnetic material to form the magnet. As the displacement piston 13 is moved through the sleeve 15, a voltage v₁ is produced between a pair of terminals 19a, 19b that are coupled to the coil 17. Movement of the displacement piston 13 can be provided directly via the button 9 by the user of the instrument 20, or indirectly by any of a variety of mechanical linkages to the displacement piston 13. In alternative embodiments of the present invention, the coil 17 can be included on the displacement piston 13 and the sleeve 15 can include a magnet. FIG. 2 shows the sleeve 15 in a fixed position on the instrument 20 with the displacement piston 13 slideably mounted in the sleeve 15. The transducer 12 alternatively includes any suitable electro-mechanical configuration or arrangement that provides for relative movement between the displacement piston 13 and the sleeve 15 to generate an electromotive force that provides the voltage v₁. The magnetic field provided by the magnet, the number of windings included in the coil 17, and the proximity of the windings in the coil 17 to the magnet are selected so that for the relative displacement, the speed, and the force that the user imparts on the button 9 to provide the relative motion between the displacement piston 13 and the sleeve 15, sufficient electrical power is generated for the monitor 16.

In alternative embodiments, the transducer 12 includes a rotary emf generator 30 as shown in an alternative example of the transducer 12 in FIG. 3. The rotary emf generator 30 is coupled to a piston 33 and guide 35, via a gear assembly 32 that converts a relative linear displacement between the piston 33 and guide 35 to rotation of a rotor 38 in the rotary emf generator 30. As the piston 33 is moved through the guide 35, a voltage v₁ is produced between a pair of terminals 39a, 39b that are coupled to a coil 37 in a stator 31 in the rotary emf generator 30. Movement of the piston 33 can be provided directly via the button 9 by the user of the instrument 20, or indirectly by any of a variety of mechanical linkages to the piston 33. In alternative embodiments of the present invention, the coil 37 can be included on the rotor 38 and the stator 31 can be magnetized to include a magnet. While the guide 35 is typically in a fixed position on the instrument 20 with the piston 33 slideably mounted in the guide 35, the transducer 12 alternatively includes any suitable electromechanical configuration or arrangement that provides for relative rotation between the rotor 38 and the stator 31 to generate an electro-motive force that provides the voltage v₁. The magnetic field provided by the magnet, the number of windings included in the coil 37, the proximity of the windings in the rotary emf generator 30 to the magnet, and the gearing within the gear assembly 32 are selected so that for the relative displacement, the speed, and the force that the user imparts on the button 9 to provide the relative motion between the rotor 38 and the stator 31, sufficient electrical power is generated for the monitor 16.

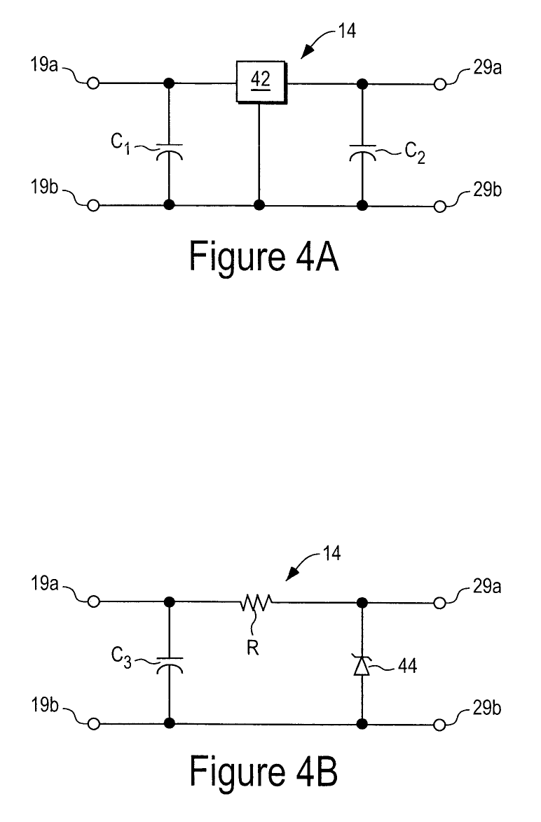

The power conditioner 14 (shown in FIG. 2) is coupled to the pair of terminals 19a, 19b of the transducer 12. The power conditioner 14 receives electrical power from the transducer 12 and then provides conditioned power to the monitor 16 via a pair of terminals 29a, 29b. FIGS. 4A-4B show examples of alternative types of voltage regulation circuits that are suitable for inclusion in the power conditioner 14. The power conditioner 14 of FIG. 4A includes an input capacitor C₁ coupled across the terminals 19a, 19b, an output capacitor C₂ coupled across the terminals 29a, 29b and a regulator 42, such as a linear voltage regulator or a switching voltage regulator, coupled between terminal 19a, terminal 29a, and terminals 19b, 29b. The power conditioner 14 of FIG. 4B includes an input capacitor C₃ coupled across the terminals 19a, 19b, a series resistor R coupled between the terminal 19a and the terminal 29a, and a shunt regulator 44, such as a Zener diode, coupled between terminal 29a and terminal 29b. While FIGS. 4A-4B provide examples of the power conditioner 14, any suitable device, element or system suitable for conditioning electrical power provided by the transducer 12 to a form suitable for use by the monitor 16 is alternatively used. When the electrical power provided by the transducer 12 is suitable for direct use by the monitor 16, the power conditioner 14 can comprise a direct connection between the transducer 12 and the monitor 16.

FIG. 2 shows the monitor 16, the instrument circuitry 18, the power conditioner 14, and the transducer 12 as separate elements for the purpose of illustration. However, the monitor 16, the instrument circuitry 18, the power conditioner 14, and the transducer 12 are alternatively implemented so that one or more of these elements are integrated. Alternatively, the elements shown in FIG. 2 are implemented in a distributed fashion, wherein the physical boundaries between the elements shown are different from those indicated in FIG. 2.

The monitor 16 does not rely on power from the power source 22 of the instrument 20 when the instrument 20 is in an OFF state. In the OFF state, the control switch S1 is open, decoupling the instrument circuitry 18 from the power source 22. An optionally included directional switch S2, such as a diode, is in a non-conducting state when the instrument 20 is in the OFF state. Upon application of mechanical power to the button 9 of the transducer 12, by a user of the instrument 20 for example, the monitor 16 receives electrical power via the power conditioner 14 that is sufficient to operate the monitor 16. The electrical power provided by the transducer 12 is sufficient to operate the monitor 16 until the power source 22 is coupled to the instrument circuitry 18 via closing of the control switch S1. Closing the control switch S1 also switches the directional switch S2 to a conducting state, so that electrical power to the monitor 16 is then provided from the power source 22.

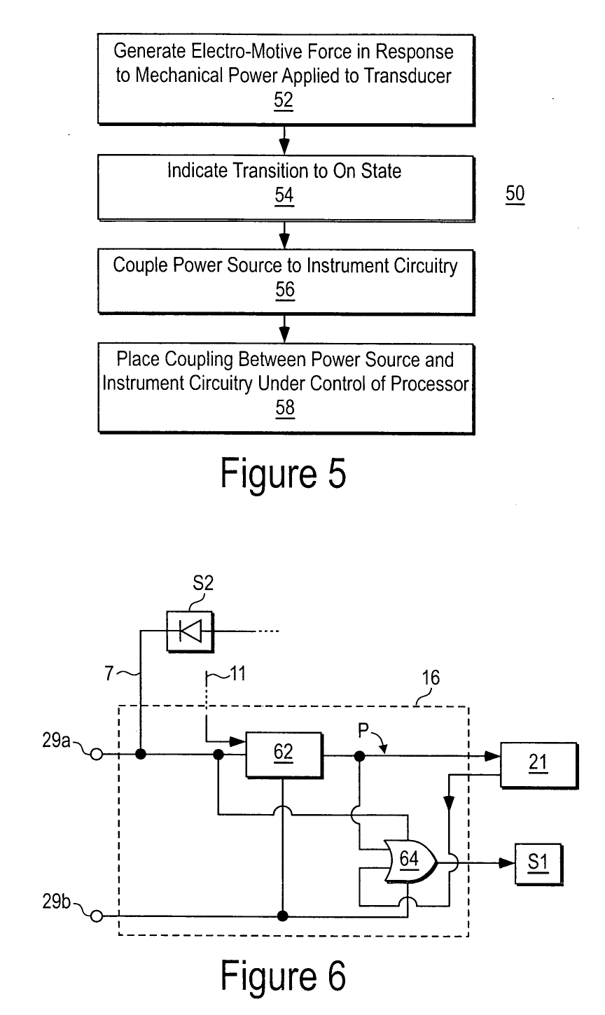

FIG. 5 is a flow diagram of one example of a power switch system 50 according to alternative embodiments of the present invention. Step 52 of the flow diagram includes applying mechanical power to the transducer 12 to generate the electromotive force that provides the voltage v₁ at the terminals 19a, 19b of the transducer 12. Step 54 of the flow diagram 50 includes indicating a transition to the ON state of the instrument 20. This indication is provided once the electromotive force is generated in step 52, typically by the closing of a contact switch S3. Closing the contact switch S3 grounds a signal line 11, which is detected by the monitor 16. The transition to the ON state in step 54 is alternatively indicated by the monitor 16 detecting the electrical power that is provided by the transducer 12.

In step 56 of the flow diagram, the power source 22 is coupled to the instrument circuitry 18, once the transition to the ON state is indicated in step 54. Typically, the monitor 16 drives the control switch S1 that, when closed, couples the power source 22 to the instrument circuitry 18. In an optional step 58, control of the switch S1 that provides for the coupling between the power source 22 and the instrument circuitry 18 is placed under the control of a processor 21 within the instrument 20. This is typically provided after a delay that is induced by the monitor 16.

FIG. 6 shows one example of a monitor 16 suitable for inclusion into the power switch system 10, and suitable for implementing steps 54-58 of the power switch system 50. The monitor 16 receives terminals 29a, 29b of the power conditioner 14. The terminal 29a receives a connection 7 to the directional switch S2. A one-shot timer 62 is triggered by the grounding of the signal line 11, indicating a transition to the ON state of the instrument 20. The one-shot timer 62 provides a pulse P to a first input to a gate 64 that closes the control switch S1. The pulse P has a pulse width, or duration, sufficiently long for the processor 21 to assume control of the switch S1 via a second input to the gate 64. In one example, the pulse P has a 200 millisecond duration, which is sufficiently long to enable the processor 21 to assert and maintain a signal to the second input to the gate 64. The monitor 16 can also include additional circuitry (not shown) to mitigate the effects of switch bounce of the contact switch S3, or to provide various other functions during transition of the instrument 20 to the ON state.

When in the instrument 20 is in the ON state, processor 21 monitors the output of the one-shot timer 62. Another pulse P, triggered by the grounding of the signal line 11, is detected by the processor 21 from the one-shot timer 62, indicating a transition from the ON state to the OFF state of the instrument 20. In response to this detected pulse P, the processor 21 initiates a shutdown of the instrument 20. The processor 21 provides a pulse to the second input of the gate 64 that is longer than the pulse P provided by the one-shot timer 62. To complete the shutdown of the instrument 20, the processor 21 de-asserts the signal that the processor 21 previously applied to the second input of the gate 64. This opens the control switch S1, disconnecting the power source 22 from the instrument circuitry 18 and setting the directional switch S2 between the monitor 16 and the power source 22 to a non-conducting state.

While the embodiments of the present invention have been illustrated in detail, it should be apparent that modifications and adaptations to these embodiments may occur to one skilled in the art without departing from the scope of the present invention as set forth in the following claims.

1. A power switch system for an instrument, comprising:
a transducer converting mechanical power to electrical power; and
a power conditioner coupled between the transducer and a monitor, the power conditioner providing electrical power to the monitor in response to mechanical power applied to the transducer.

2. The power switch system of claim 1 wherein the transducer includes one of a linear electromotive force generator and a rotary electromotive force generator.

3. The power switch system of claim 1 further comprising a contact switch selectively grounding a signal line coupled to the monitor, the contact switch indicating a transition between an ON state and an OFF state of the instrument.

4. The power switch system of claim 3 wherein the monitor drives a control switch that selectively couples a power source to instrument circuitry in response to the selective grounding of the signal line.

5. The power switch system of claim 4 further comprising a directional switch providing electrical power to the monitor from the power source when the control switch couples the power source to the instrument circuitry.

6. The power switch system of claim 5 wherein the directional switch decouples the monitor from the power source when the instrument is in an OFF state.

7. The power switch system of claim 4 further including a processor controlling the coupling between the power source and the instrument circuitry after an imposed delay from an indicated transition from the OFF state of the instrument to the ON state of the instrument.

8. The power switch system of claim 7 wherein the processor controls the coupling between the power source and the instrument circuitry via the control switch.

9. A power switch system for an instrument, comprising:
generating an electromotive force in response to mechanical power applied to a transducer;
indicating a transition to an ON state of the instrument; and
coupling a power source to instrument circuitry in response to the indicated transition to the ON state of the instrument.

10. The power switch system of claim 9 further comprising controlling coupling between the power source and the instrument circuitry with a processor after an imposed delay from the indicated transition to an ON state of the instrument.

11. The power switch system of claim 9 wherein indicating the transition to the ON state of the instrument includes grounding a signal line.

12. The power switch system of claim 9 wherein indicating the transition to the ON state of the instrument includes detecting the electromotive force generated in response to the mechanical power applied to the transducer.

13. The power switch system of claim 9 wherein coupling the power source to the instrument circuitry includes closing a control switch that selectively couples the power source to the instrument circuitry.

14. A power switch system for an instrument, comprising:
providing electrical power to a monitor from an electromotive force generated in response to mechanical power applied to a transducer;
indicating to the monitor a transition to an ON state of the instrument; and
coupling a power source to instrument circuitry in response to the transition to the indication of the ON state of the instrument to the monitor.

15. The power switch system of claim 14 further comprising controlling coupling between the power source and the instrument circuitry with a processor after an imposed delay from the indicated transition to the ON state of the instrument to the monitor.

16. The power switch system of claim 14 wherein indicating the transition to the ON state of the instrument includes grounding a signal line.

17. The power switch system of claim 14 wherein indicating the transition to the ON state of the instrument includes detecting the electro-motive force generated in response to the mechanical power applied to the transducer.

18. The power switch system of claim 15 wherein controlling coupling between the power source and the instrument circuitry includes controlling a control switch that selectively couples the power source to the instrument circuitry.

19. The power switch system of claim 15 further comprising providing electrical power to the monitor from the power source when the power source and the instrument circuitry are coupled.

20. The power switch system of claim 18 further comprising decoupling the monitor from the power source when the power source and the instrument circuitry are not coupled.
